(19) United States
(12) Patent Application Publication
(10) Pub. No.: US 2008/0149205 A1
(43) Pub. Date: Jun. 26, 2008

(54) SYSTEM AND METHOD FOR REDUCING WAKE

(75) Inventors: Anurag Gupta, Clifton Park, NY (US); Chingwei Michael Shieh, Mechanicville, NY (US); Seyed Gholamali Saddoughi, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/613,389

(22) Filed: Dec. 20, 2006

(51) Int. Cl. F15C 3/00

(52) U.S. Cl. 137/829

(57) ABSTRACT

A machine includes an unsteady blower device, such as a synthetic jet actuator, disposed such that an aperture of the blower is disposed upon the trailing edge of the machine component. The unsteady blower device is actuated to perform unsteady blowing of a fluid from the aperture in order to enhance turbulent mixing in the flow to mitigate undesirable wakes that interact with downstream components. Such unsteady blower devices facilitate momentum transfer or unsteady excitation or energy addition into the flow through the machine via direct injection of additional fluid.

### BACKGROUND

The invention relates generally to techniques for reducing noise and aeromechanical stress associated with machine wakes, and more particularly relates to a system and method for reducing noise and aeromechanical stress associated with airflow over components of machines.

In rotating machines, noise is generated due to interaction of air or fluid with the machine's operative surfaces. Examples of such rotating machines include aircraft engines, fluid pump impellers, pump inlets, pump diffusers, marine propellers, air conditioners, high speed blowers, and the like. A significant cause of noise emanating from rotating machines is due to the wakes that are generated behind stationary components (e.g., frames, struts, vanes etc) and rotating components (fans, rotors etc), which then interact with downstream components (causing a rotor-stator wake interaction) and a resulting unsteady loading on the machine components. In addition to noise, this wake interaction and related unsteady aeromechanical loading on downstream structures produces stress and is a cause of high-cycle fatigue of rotor blades.

In one example, in aircraft engines, steady blowing of air via slots or discrete injection holes provided in an aft section of rotor fan blades has been extensively explored to mitigate wake by the concept of wake filling. The steady blowing of fluid to fill out the wake is acoustically effective. However, the system costs of the wake-filling concept have proven to be too high to be integrated with any current commercial aircraft engines. The problem related to wake mitigation has also sought to be tackled by increasing spacing between blade rows and altering geometry of the blade rows (for example, the lean and sweep of the blades). However, this arrangement has limited effectiveness and also leads to larger system costs.

Accordingly, there is a need for a system and method that enables effective reduction of noise and aeromechanical impact associated with wakes interacting with downstream components in machines. Also, there is a need for a wake mitigation system that is effectively integrated with fan and rotor blades.

### BRIEF DESCRIPTION

In accordance with one exemplary embodiment of the present invention, a rotary machine includes a first set of components and a second set of components disposed downstream within the fluid flow with respect to the first set of components. A fluid flow control system is coupled to the first set of components. The fluid flow control system includes an unsteady blower device that includes an aperture disposed upon a surface of the first set of components. The unsteady blower device is configured to perform unsteady blowing of a fluid from the aperture to enhance mixing in the fluid flow over the first set of components in order to mitigate a wake in the flow that interacts with the second set of components.

In accordance with another exemplary embodiment of the present invention, a method of operating a rotary machine includes passing a fluid flow through the machine over a first set of components and a second set of components, the second set of components being disposed in the fluid flow downstream of the first set of components. The method also includes performing unsteady blowing of a fluid from a trailing edge of the first set of components via an unsteady blower device to enhance mixing in the fluid flow in order to mitigate a wake in the flow that interacts with the second set of components.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an aircraft having wake mitigation features in accordance with an exemplary embodiment of the present invention;

FIG. 2 is a diagrammatical view of an engine, such as an aircraft engine, having wake mitigation features in accordance with an exemplary embodiment of the present invention;

FIG. 3 is a diagrammatical view of an exemplary deployment configuration of a system for wake mitigation in an aircraft engine in accordance with an exemplary embodiment of the present invention;

FIG. 4 is a diagrammatical view of an unsteady blower device such as a synthetic jet fluidic actuator that can be integrated into a co-operative or interdependent array of actuators in accordance with an exemplary embodiment of the present invention;

FIG. 5 is a diagrammatical view of an array of fluidic oscillators in accordance with an exemplary embodiment of the present invention;

FIG. 6 is a diagrammatical view of an array of fluidic oscillators deployed in a gas turbine engine in accordance with an exemplary embodiment of the present invention;

FIG. 7 is a diagrammatical representation of an unsteady blower device having a plurality of injection slots provided in a trailing edge of a rotor blade of an aircraft engine in accordance with an exemplary embodiment of the present invention;

FIG. 8 is a diagrammatical representation of an unsteady blower device provided in a trailing edge of a rotor blade of an aircraft engine in accordance with an exemplary embodiment of the present invention;

FIG. 9 is a diagrammatical representation of an unsteady blower device provided in a trailing edge of a rotor blade of an aircraft engine in accordance with another exemplary embodiment of the present invention;

FIG. 10 is a diagrammatical representation of an unsteady blower device provided in a trailing edge of a rotor blade of an aircraft engine in accordance with yet another exemplary embodiment of the present invention;

FIG. 11 is a diagrammatical representation of a plurality of unsteady actuators provided to alternate blades among a plurality of rotor blades of a rotary machine in accordance with an exemplary embodiment of the present invention; and

FIG. 12 is a diagrammatical representation of a plurality of unsteady actuators provided partially along a plurality of rotor blades of a rotary machine in accordance with an exemplary embodiment of the present invention.

### DETAILED DESCRIPTION

How control techniques may be used to improve aerodynamics and general flow performance in a variety of applications, including aircraft engines, aircraft wings, various airfoils, industrial ducts, pneumatic transports, boats, submarines, marine projectiles, various parts of wind turbines such as stalls, lifts, gusts and so forth. As discussed in detail below, embodiments of the present invention provide a rotary machine having two sets of components rotatable with respect to one another. In certain embodiments, these components may include rotors and stators. As used herein, the term “stator” may include such elements as stator blades, outlet guide vanes, blowing struts, or the like. The term “rotor” may include one or more rotor blades, fan blades, or other rotating components within devices such as gas turbine engines. In a typical gas turbine engine, rotors and stators are arranged in such a way that airflow past an upstream component will tend to produce a wake that impinges upon a downstream component. In the examples shown and described herein, the rotors are generally located upstream of the stators, such that wake produced by the flow of fluid over the rotors impinges upon the stators and other downstream structures. However, it will be understood by one of ordinary skilled in the art that the techniques and systems described can be applied to any form of wake or acoustic disturbance produced by one component rotating with respect to another downstream component.

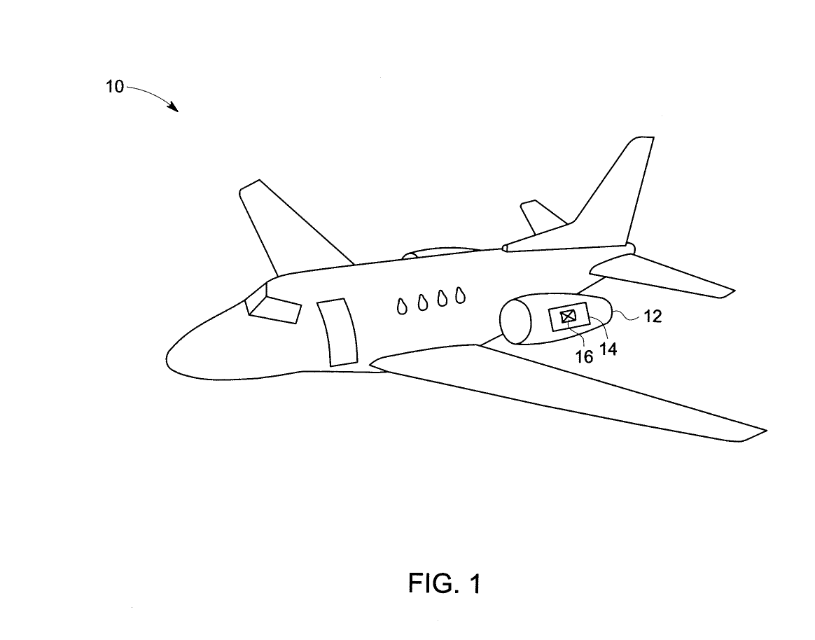

In an exemplary embodiment, one component (the upstream component) includes an unsteady blower device integrated to a trailing edge of the component. As used herein, the term “trailing edge” refers to the most downstream edge of the component, and the portion of the component immediately upstream of this edge where the flow over that portion is affected by the edge of the component. The unsteady blower device is configured to intermittently inject fluid from a trailing edge of the component to mitigate wakes produced in the flow through the machine, including wakes resulting from fluid flow over the component itself. The unsteady blower device may include an active device or a passive device. Examples of active devices, which generally require power input and may or may not have moving parts, may include synthetic jets, plasma actuators, valve mechanisms, and other electromechanical and electromagnetic devices. Passive devices that can be used for unsteady blowing include fluidic oscillators and flip-flop jets. These passive devices require a steady source of energy such as pressurized air to power the devices. Such unsteady blower devices facilitate momentum transfer or unsteady excitation or energy addition into the flow through the machine via direct injection of additional fluid and also produce unsteady mixing of the flow along the surface of the components during operation of the machine. This mixing smoothes out variations in the flow and damps out the wake produced by the components. Specific embodiments of the present invention are discussed below referring generally to FIGS. 1-12.

In certain exemplary embodiments, wake mitigation is achieved by using unsteady actuators to modify the wakes behind the two sets of components in a time-dependent fashion. The objective is to mix the wakes out faster using unsteady momentum injection in addition to using the injected momentum to reduce the initial defect. The mitigation methods can be tailored to create temporal and spatial variations of the wake that interacts with downstream blading. The excitation provided by the unsteady actuators enhances the flow instability and creates spatial and temporal disturbances such as swirl and streamwise vortices that promote the mixing of high and low-momentum flow regions, resulting in a more mixed-out wake. This is different from the wake filling technique in which additional fluid is directly injected into the wake to fill up the defect.

Referring to FIG. 1, an aircraft 10 having specific flow control features is illustrated in accordance with certain exemplary embodiments of the present invention. The aircraft 10 includes a propulsion assembly 12 having an aircraft engine 14. The engine 14 includes a fluid flow control system 16 configured to control the air pressure, flow, boundary layer behavior, or aerodynamics of the engine 14. As discussed in further detail below, the fluid flow control system 16 includes an unsteady blower device having for example, a plurality of active or passive devices, such as synthetic jets or fluidic oscillators. The number of devices, location, relative dimensions, and arrangements may be varied depending on the requirement.

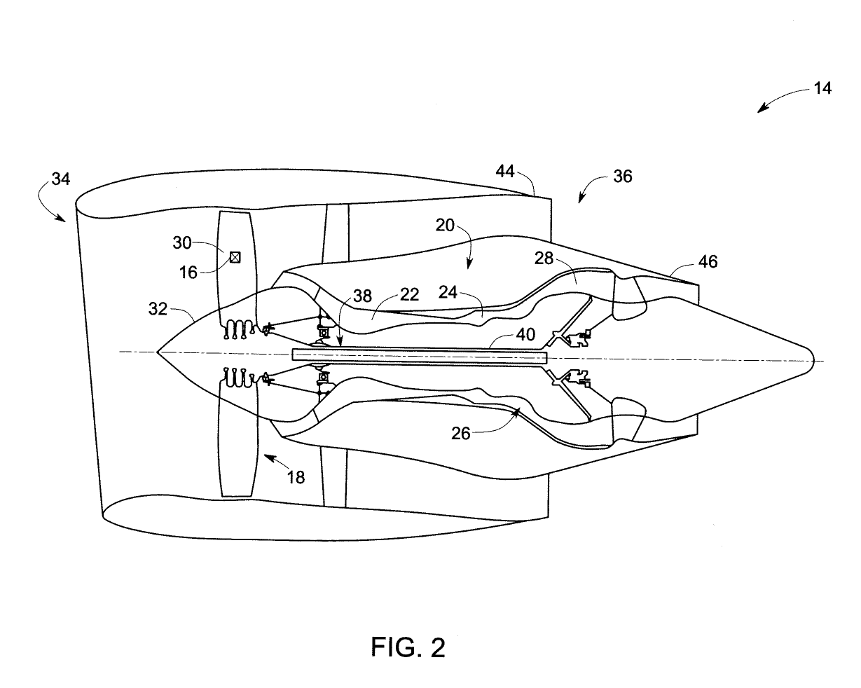

FIG. 2 is a diagrammatical view of an engine, such as an aircraft engine or a gas turbine engine 14, having wake mitigation features in accordance with an exemplary embodiment of the present invention. The illustrated engine 14 is a detailed view of one embodiment of the aircraft engine 14 shown in FIG. 1. The engine 14 includes a fan assembly 18 and a core engine 20 having a high pressure compressor 22, and a combustor 24. The engine 14 also includes a high pressure turbine 26, a low pressure turbine 28, and a booster (not shown). The fan assembly 18 includes an array of rotor blades (fan blades) 30 extending radially outward from a rotor disc 32. Engine 14 includes an intake side 34 and an exhaust side 36. Fan assembly 18 is coupled to the turbine 28 via a first rotor shaft 38 and the compressor 14 is coupled to the turbine 18 via a second rotor shaft 40.

During operation, air flows through the fan assembly 18 and compressed air is supplied to the high pressure compressor 22. The highly compressed air is delivered to the combustor 24. Airflow from combustor 24 drives the turbines 26 and 28, and the turbine 28 drives the fan assembly 18 via the shaft 38. More specifically, to produce thrust from engine 14, the fan discharge flow is discharged through the fan exhaust nozzle 44, and the core combustion gases are discharged from the engine 14 through a core engine exhaust nozzle 46. In one embodiment, the engine 14 is operated at a relatively high bypass ratio, which is indicative of the amount of fan air, which bypasses the core engine 20 and is discharged through a fan exhaust nozzle 44, compared to the airflow through the core engine 20. In an alternative embodiment, the gas turbine engine 14 is operable with a low bypass ratio. In the illustrated embodiment, the system 16 for controlling the flow of a fluid may be located in at least one fan blade 30. The details of the system 16 are explained in greater detail with reference to subsequent figures.

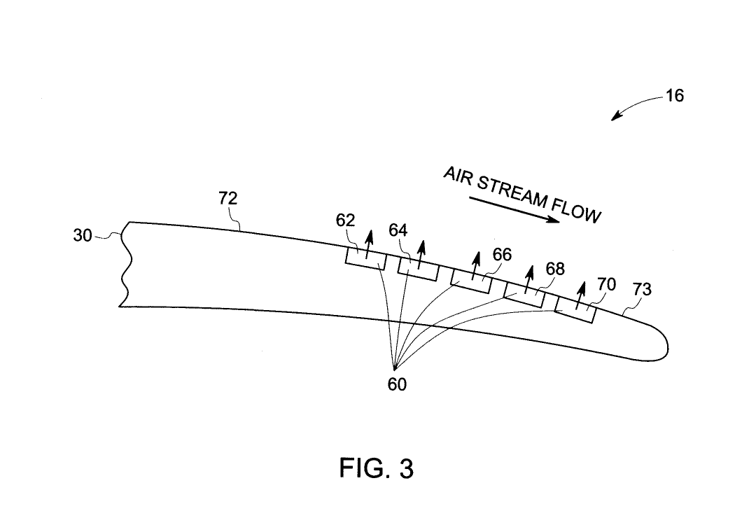

FIG. 3 is a diagrammatical view of an exemplary deployment configuration of the system 16 for wake mitigation in the aircraft engine of FIG. 2. In the illustrated exemplary embodiment, fluid flow control system 16 is an active device. The system 16 includes an array 60 of synthetic jet actuators, made up of actuators 62, 64, 66, 68, and 70 that extend along an exemplary flow boundary surface 72 of a trailing edge 73 of the rotor blade 30. In the illustrated embodiment, the array 60 of synthetic jet actuators includes an array of dual bimorph synthetic jet (DBSJ) actuators. Although five synthetic jet actuators are illustrated in this unsteady blower device, in certain other exemplary embodiments, the number of synthetic jet actuators in the array 60 may vary depending upon the requirement. The array 60 of interdependent actuators 62, 64, 66, 68, and 70 may be positioned within the rotor blade 30 below the flow boundary surface 72 of the trailing edge 73 via a suitable mounting mechanism. For example, the synthetic jet actuators 62, 64, 66, 68, and 70 may extend radially inward from an orifice plate attached to the flow boundary surface 72 of the trailing edge 73. The orifice plate may form a part of the flow boundary surface 72. The illustrated embodiment shows an array of actuators disposed along the chord of the blade, but it will be understood that other arrangements are possible. For example, the actuators may be arranged in one or more span-wise rows parallel to the trailing edge 73 of the blade 30.

The synthetic jet actuators 62, 64, 66, 68, and 70 are configured to perform unsteady blowing of a fluid from the trailing edge 73 of the rotor blade 30 into an external air stream flowing along the boundary surface 72 to mitigate wake.

Structurally, the synthetic jet actuators 62, 64, 66, 68, and 70 may be piezoelectric devices that function like bellows to create alternating expansion and contraction pulses through fluid outlets or flow control ports, as will be described in greater detail below. The small pulsating flows of control fluid coming out of the flow control ports of the synthetic jet actuators 62, 64, 66, 68, and 70 may be designed and utilized to change flow behavior of much larger flows in aerodynamic applications, such as boundary layer control of the larger flows. In the illustrated exemplary embodiment, the synthetic jet actuators 62, 64, 66, 68, and 70 are placed in the array 60 to create a series of fluidic control flow points over the flow boundary surface 72.

Specifically, the synthetic jet actuators 62, 64, 66, 68, and 70 expel air at a sufficient magnitude and orientation with respect to the external airflow stream so as to generate stream-wise vortices in the external airflow. The pulse of fluid expelled from the actuator or other blower causes stream-wise vortices to be created in the flow along the surface as it is diverted by the temporary fluidic obstacle expelled from the actuator. These vortices introduce additional swirl into the flow along the surface of the blade and effectively stir the surface flow into the surrounding flow more quickly than would otherwise occur. This enhanced mixing action tends to damp out variations in the flow, such as pressure differentials, that are created in the wake of the blade.

In certain exemplary embodiments, the synthetic jet actuators 62, 64, 66, 68, and 70 are selectively operatable to expel fluid into the external airflow stream only when there is a particular need to mitigate the wake produced. For example, if a strong and potentially undesirable wake tends to be created only during certain engine operating conditions (e.g. high engine rpm), the actuators need only be activated when the engine rpm is above a particular threshold. Similarly, if different portions of the engine experience undesirable wake formation under different operating conditions, the actuators associated with the separate portions of the engine (for example, different sets of rotors within the engine) may each be independently activated only when there is a need for wake mitigation in that region of the engine. By selectively operating the actuators only when needed, the system costs associated with operating the actuators are minimized, allowing the engine to operate more efficiently and not suffer the performance losses associated with running the actuators during flight regimes where boundary layer control is not employed.

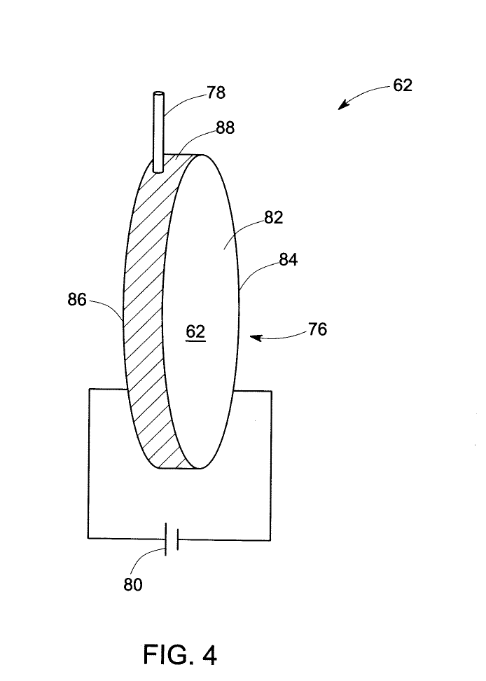

FIG. 4 is a diagrammatical representation of an exemplary synthetic jet actuator 62 that is integrated into the array 60 of actuators 62, 64, 66, 68, and 70 in accordance with an exemplary embodiment of the present invention to control fluid flow in association with operation of the engine. In the illustrated embodiment, the fluidic jet actuator 62 includes an actuator body 76, a flow control port 78 and a common source of voltage 80. The actuator body 76 includes a fluidic chamber 82 that is coupled in flow communication with the exemplary boundary surface (72, illustrated in FIG. 3) through the flow control port 78. The actuator body 76 includes a pair of circular side walls 84, 86 that are coupled together via a flexible spacer ring 88. Spacer ring 106 encircles the space formed between the side walls 84, 86 and may overlap a portion of the side walls 84, 86 such that the spacer ring 88 holds the side walls 84, 86 together while defining a portion of chamber 82. The spacer ring 88 includes a suitable flexible, fluid-tight material.

In certain embodiments, the sidewalls 84, 86 include a plurality of generally planar stacked layers. More specifically, the side walls 84, 86 includes two piezoelectric layers having opposite polarities. When a voltage is applied to actuator jet 62, one layer expands while the other layer contracts.

The source 80 provides an alternating voltage of a predetermined magnitude and frequency to the side walls 84, 86. During operation, voltage is applied is applied to the side walls 84, 86 so as to cause the side walls 84, 86 to expand in opposite directions relative to each other. More specifically, when one side wall 84 is expanded convexly outward, the other opposite side wall 86 is also expanded convexly outward in an opposite direction. The simultaneous expansion of side walls 84, 86 causes a decreased partial pressure within the fluid chamber 82 which in turn causes the fluid to enter chamber 82 through the flow control port 78. In one exemplary embodiment, the synthetic jet actuator 62 is operated in a pulsating mode.

When a voltage of opposite polarity is applied to the side walls 84, 86, the side walls 84, 86 bend in mutually opposite direction (i.e. becomes concave rather than convex). The simultaneous expansion of the side walls 84, 86 reduces the volume of fluid chamber 82 and causes the fluid to be expelled through the flow control port 78. In certain exemplary embodiments, the actuator body 76 may include a plurality of flow control ports arranged around a periphery of the actuator body 76. The number of flow control ports may be selected according to the physical space available, desired orientation of the ports, and the desired output among other factors. The outlet discharge velocity may be reduced by adding additional flow control ports. As noted above, although the illustrated examples show a particular design of synthetic jet, it will be appreciated that a variety of similar structures can be used to produce unsteady blowing suitable for producing pulses of fluid for wake mitigation.

FIG. 5 is a diagrammatical view of a system 16 for wake mitigation in the aircraft engine in accordance with another exemplary embodiment of the present invention. In the illustrated embodiment, the system 16 is a passive unsteady blower device. The system 16 includes an array 90 of fluidic oscillators in accordance with an exemplary embodiment of the present invention. The array of fluidic oscillators 90 includes an exemplary first fluidic oscillator 92, an exemplary second fluidic oscillator 94, an exemplary third fluidic oscillator 96 and so on. The operation of one exemplary type of fluidic oscillator is described in U.S. Pat. No. 7,128,082 entitled “Method and System for Flow Control with Fluidic Oscillators”, which is incorporated in its entirety herein by reference.

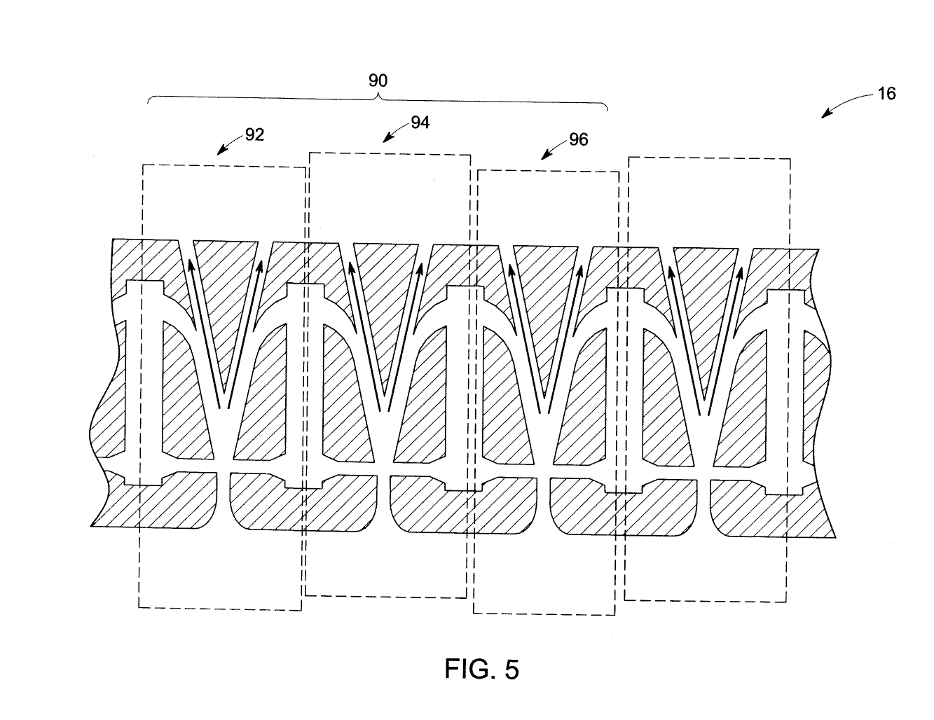

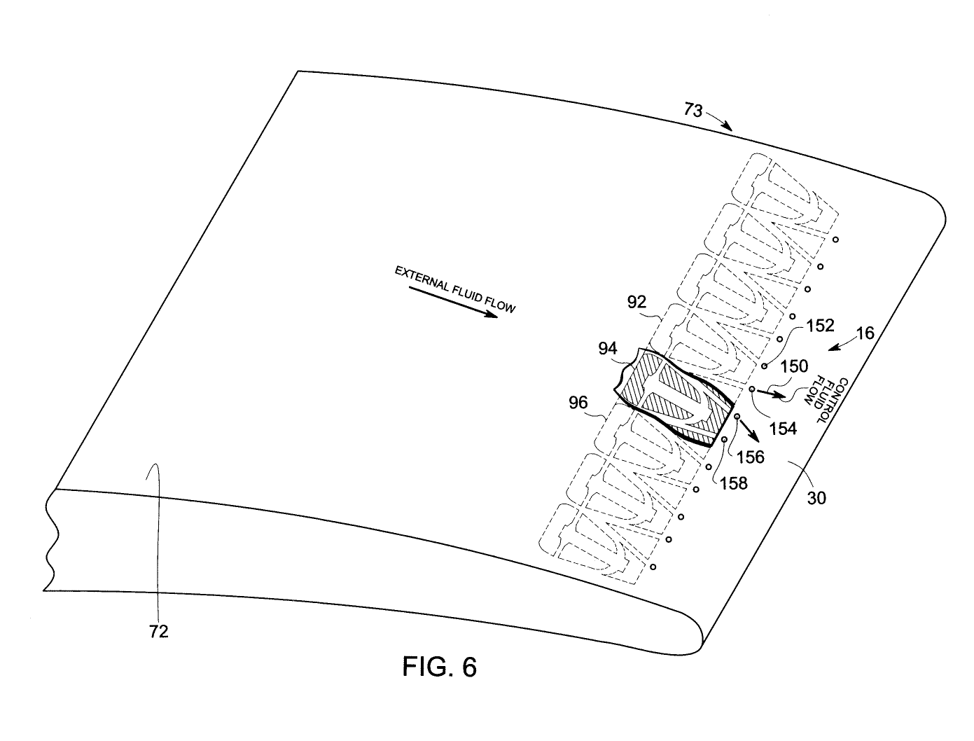

Referring to FIG. 6, a diagrammatical view of an array of fluidic oscillators 92, 94, 96, and so on deployed in the rotor blade 30 of the gas turbine engine in accordance with an exemplary embodiment of the present invention. The system 16 includes an unsteady blower device made up of an array of fluidic oscillators 92, 94, 96, and so on deployed along the exemplary flow boundary surface 72 of the trailing edge 73 of the rotor blade 30. The first oscillator 92 and the second oscillator 94 in an exemplary instance facilitate wake mitigation by injecting fluid into the external airflow stream along the flow boundary surface 72. More specifically, wake mitigation is achieved in a manner similar to that described above with respect to synthetic jet actuators, i.e. by the unsteady mixing produced by the oscillating output jets.

In certain exemplary embodiments of the present invention, the relatively small size of the fluidic oscillators 92, 94, 96 and so on allow implementation in narrow vanes and passages. In certain other exemplary embodiments, the blade may include a stator blade, guide vane, compressor blade, or any similar structure as is found in a gas turbine engine or other turbo machinery. In the illustrated embodiment, the array of fluidic oscillators 92, 94, 96, and so on are shown disposed spanwise along the trailing edge of the blade 30. However, as noted above, the fluidic oscillators could be disposed in other arrangements as well without departing from the spirit of this invention.

In the illustrated exemplary embodiment of the present invention, a number of holes 152, 154, 156, and 158 are provided circumferentially along the flow boundary surface 72 of the trailing edge 73 of the rotor blade 30. The fluidic oscillators 92, 94, 96 and so on are so deployed in such a way that each of the output ports 22, 24, 42, and 44 (illustrated in FIG. 6) coincide with one of the holes 82 or 84 or 86 or 88 and so on. During operation, the fluidic oscillators 92, 94, 96, and so on may receive a steady stream of the control fluid 74 via a common plenum from typical auxiliary fluid sources and in turn, allow flow of the control fluid 150 over the gas turbine blade 30 through the holes 82, 84, 86, 88 and so on. The holes 82, 84, 86, 88 and so on thus form an array of holes that is coherently emitting pulsating jets of the control fluid 150 into the external airflow stream along the flow boundary surface 72. In certain exemplary embodiments, a number of slots are provided circumferentially along the flow boundary surface 72 of the trailing edge 73 of the rotor blade 30. The fluidic oscillators 92, 94, 96, and so on may be formed using heat resistant materials and are designed with no moving parts, allowing them to more effectively operate in a fluid flow region with high temperatures during a gas turbine engine operation. As with the synthetic jet actuators described above, a number of fluidic oscillators may be independently operable and configurable for selective operation in various operating regimes or locations of the engine.

Although the illustrated embodiments show holes of a generally circular shape as the output ports for injecting flow into the boundary layer, it will be understood that the output ports may take a variety of shapes, including straight slots, curved slots, v-shaped slots, and oval or elongated curved holes. Any of these various forms of aperture may be used singly or in combination as the output ports for the various unsteady blowing devices described herein.

In a jet of control fluid that typically exits from a conduit to a surrounding medium of another fluid, the sudden increase of the mass-flow leads to formation of well-defined vortices that dominate the boundary between the control fluid and the surrounding main fluid, as discussed above. Because these vortices help redistribute momentum over a large distance, the rate of turbulent mixing between the control fluid and the main fluid is closely linked to the dynamics of these vortices. One way to manipulate the dynamics of the vortices is to modulate the instantaneous mass-flux of the jet.

In one embodiment of the invention, this variation in the frequency and amplitude of oscillation of the control fluid may also be accomplished by modulating the driving pressure of the control fluid. The driving pressure of the control fluid and the volumes of the feedback chambers may typically be varied independently to deliver the required amplitude and frequency for wake mitigation. In embodiments making use of other unsteady blowing devices, such as synthetic jets or valves, the modulation of the control fluid may be accomplished by modulating the control inputs of the device, such as the frequency and amplitude of the driving voltage of the synthetic jet.

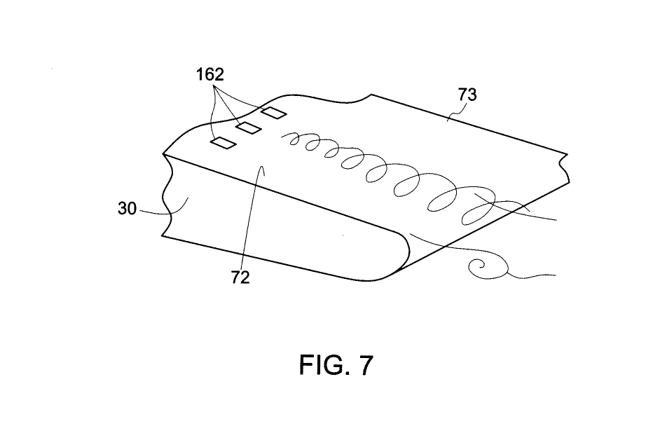

FIG. 7 is a diagrammatical representation of the unsteady blower device having a plurality of injection slots 162 provided along the boundary surface 72 in the trailing edge 73 of the rotor blade 30 in accordance with an exemplary embodiment of the present invention. The unsteady blower device is configured to perform unsteady blowing of a fluid through the slots 162 of the rotor blade 30 to mitigate wake. The unsteady blower device facilitates momentum transfer in combination with an unsteady mixing of air along the surface of the trailing edge during operation of the blower. It should be noted herein that the location, number and relative dimensions of the slots 162 may be varied depending on the need to mitigate wakes at different times or locations during engine operation.

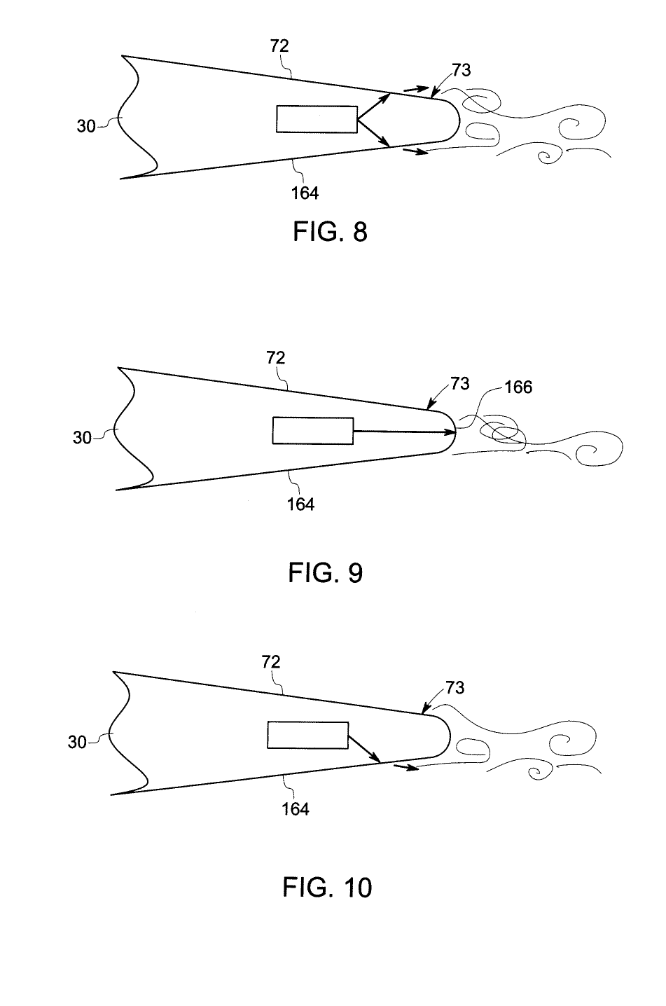

FIG. 8 is a diagrammatical representation of an unsteady blower device integrated to both a suction surface 164 and the pressure surface 72 of the trailing edge 73 of the rotor blade 30 in accordance with an exemplary embodiment of the present invention. The unsteady blower device is configured to perform unsteady blowing of a fluid through the suction surface 164 and the pressure surface 72 of the rotor blade 30 to an external airflow stream to mitigate wake.

FIG. 9 is a diagrammatical representation of an unsteady blower device integrated to an end 166 of the trailing edge 73 of the rotor blade 30 in accordance with an exemplary embodiment of the present invention. The unsteady blower device is configured to perform unsteady blowing of a fluid through the end 166 of the trailing edge 73 to an external airflow stream to mitigate wake.

FIG. 10 is a diagrammatical representation of an unsteady blower device integrated only to the suction surface 164 of the trailing edge 73 of the rotor blade 30 in accordance with an exemplary embodiment of the present invention. The unsteady blower device is configured to perform unsteady blowing of a fluid through the suction surface 164 of the trailing edge 73 to an external airflow stream to mitigate wake.

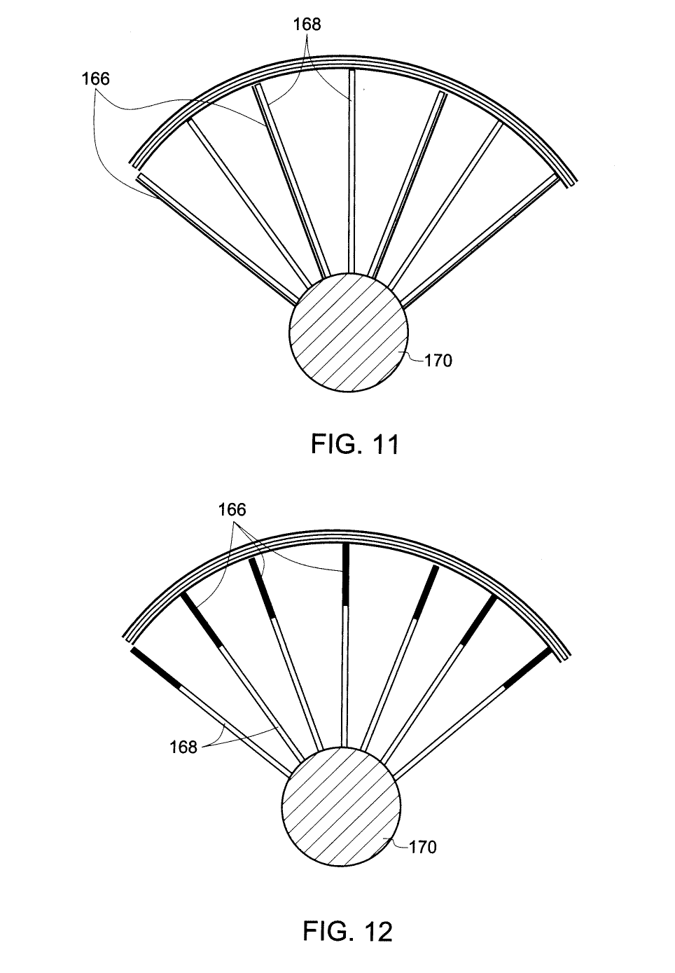

FIG. 11 is a diagrammatical representation of a plurality of unsteady blower devices or actuators 166 in accordance with an exemplary embodiment of the present invention. The unsteady actuators 166 are provided to alternate blades among a plurality of rotor blades 168 of a rotary machine. The rotor blades 168 are coupled to a rotor shaft 170. The unsteady actuators 166 may be provided partially or along the entire length of the alternate blades. It should be noted again that the number, relative dimensions, location of the actuators 166 may be varied depending on the application.

FIG. 12 is a diagrammatical representation of a plurality of unsteady actuators 166 in accordance with another exemplary embodiment of the present invention. In the illustrated embodiment, the unsteady actuators 166 are provided partially (partial span) along a plurality of rotor blades 168 of a rotary machine. The rotor blades 168 are coupled to the rotor shaft 170. In certain other embodiments, the unsteady actuators 166 are provided along the entire length of the plurality of rotor blades 168. Similarly, any number of variations in the deployment of actuators 166 are envisioned.

It should be noted that the exemplary blower device illustrated in above embodiments are adaptable to selectable operation, or sequential operation for unsteady blowing on multiple blades/struts. In addition to the examples discussed above, other possible arrangements of selectable operation in further embodiments include activating blowers only on a particular outlet guide vane or other stator during certain flight conditions. In another example, the blowing on the rotor blades may be controlled in such a way that a portion of the blowers on a blade may be activated during certain flight regimes, and blowers across the entire blade may be activated during certain other flight regimes.

In addition to the variations in selective activation above, variations in operation of the actuators on individual blades may also be tuned to synchronize the activation of the wake mitigation with a particular rotational position of the blade. For instance, if the blowers are actuated at a frequency that matches the frequency with which the blade passes a particular strut or guide vane in the engine, effectively, the wake mitigation is only activated at a particular rotational position of the blade. By varying the phase of the activation for each blade on a rotor, each blade can be made to be active only at that rotational position. In this way, mitigation may be applied selectively only for particular locations in the engine.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A machine having a fluid flow therethrough, comprising:
a first set of components;
a second set of components disposed downstream within the fluid flow with respect to the first set of components; and
a fluid flow control system coupled to the first set of components comprising:
an unsteady blower device that includes an aperture disposed upon a surface of the first set of components wherein the unsteady blower device is configured to perform unsteady blowing of a fluid from the aperture to enhance mixing in the fluid flow over the first set of components in order to mitigate a wake in the flow that interacts with the second set of components.

2. The machine of claim 1, wherein the machine comprises an aircraft engine.

3. The machine of claim 1, wherein the machine comprises a gas turbine engine.

4. The machine of claim 1, wherein the first set of components comprises rotors.

5. The machine of claim 1, wherein the second set of components comprises stators.

6. The machine of claim 1, wherein the unsteady blower device comprises a passive device.

7. The machine of claim 6, wherein the passive device comprises a plurality of fluidic oscillators.

8. The machine of claim 7, wherein the plurality of fluidic oscillators are provided on alternate rotor blades.

9. The machine of claim 7, wherein the fluidic oscillator is provided along an entire length of the rotor blade.

10. The machine of claim 7, further comprising a fluid source coupled to the plurality of fluidic oscillators and configured to supply a pressurized fluid to the fluidic oscillators.

11. The machine of claim 1, wherein the unsteady blower device comprises an active device.

12. The machine of claim 11, wherein the active device comprises a plurality of synthetic jets.

13. The machine of claim 12, wherein the plurality of synthetic jets are provided on alternate components among the first set of components.

14. The machine of claim 1, wherein the aperture comprises a member selected from the group consisting of a straight slot, a curved slot, a v-shaped slots, a circular hole, and an oval hole.

15. The machine of claim 1, wherein the aperture is disposed on a suction surface of a trailing edge of the first set of components.

16. The machine of claim 1, wherein the aperture is disposed on a pressure surface of a trailing edge of the first set of components.

17. The machine of claim 1, wherein the aperture is disposed on an end of a trailing edge of the first set of components.

18. A method of operating a machine, comprising:
passing a fluid flow through the machine over a first set of components and a second set of components, the second set of components being disposed in the fluid flow downstream of the first set of components; and
performing unsteady blowing of a fluid from a trailing edge of the first set of components via an unsteady blower device to enhance mixing in the fluid flow in order to mitigate a wake in the flow that interacts with the second set of components.

19. The method of claim 18, wherein the unsteady blower device comprises a plurality of fluidic oscillators.

20. The method of claim 18, wherein performing unsteady blowing comprises selectively activating the unsteady blower device.

21. The method of claim 18, wherein the unsteady blower device comprises a plurality of synthetic jets.

22. The method of claim 18, wherein the unsteady blower device comprises a first set of blower devices having apertures disposed on a first portion of the first set of components and a second set of blower devices having apertures disposed on a second portion of the first set of components, and wherein performing unsteady blowing comprises selectively activating the first set of blower devices independently of the activation of the second set of blower devices.

23. The method of claim 22 wherein the first set of blower devices are activated during a first operating condition of the machine and the second set of blower devices are activated during a second operating condition of the machine.

24. The method of claim 22, wherein the first set of blower devices are activated at a different frequency from a frequency at which the second set of blower devices are activated.
